(19) United States
(12) Patent Application Publication
(10) Pub. No.: US 2017/0228540 A1
(43) Pub. Date: Aug. 10, 2017

(54) Method and a system for detecting malicious code activity by generating software traps per application

(71) Applicant: APPDOME LTD., Tel Aviv (IL)

(72) Inventors: Avner Yehuda, Ramat Gan (IL); Omer Schory, Givatayim (IL)

(73) Assignee: APPDOME LTD., Tel Aviv (IL)

(21) Appl. No.: 15/018,930

(22) Filed: Feb. 9, 2016

(51) Int. Cl. G06F 21/56; H04L 29/06; G06F 21/55

(52) U.S. Cl. CPC G06F 21/566; G06F 21/554; H04L 63/1416

(57) ABSTRACT

Software traps per application that attract malicious software are created by mimicking the behavior of the application. In an embodiment, the software traps are comprised of mimicked entities which will be created and monitored to detect malicious code activity using an additional layer to the application.

### BACKGROUND

Computing systems are suffering from malicious code attacks-13 there are many types of attacks, but there are two general purposes:
1. Disrupt the system operation
2. Get confidential information

A computing system application is subjected to 3 vectors of malicious software attacks:

1. Inner device attack—one malicious app can “attack” another app on the same device
2. Outside original—malicious man-in-the-middle (external to device) can attack the app
3. Inner-app—a component inside the app can attack other parts of the app

There are existing methods for attracting attacking software called “honeypots” focusing on identifying malicious internet traffic, coming from outside the perimeter, which can result in viruses and malicious software brought to the perimeter.

Internet servers are creating complex honeypots to fight this malicious software—but once malicious software gets inside the device or even applications inside the device these methods will not work.

Traditional software honey pots are covering mostly #2 and do not address #1 and #3.

Furthermore, honey pots server services are static and complex, meaning servers inside the local network that will “attract” hackers require each of which must be set up specifically and managed by itself.

There are also solutions for mimicking a full application—such solutions can be effective in detecting in device attacks but not in application malware.

A mobile application in most smart phone system is in a “sand box” environment—a per application micro virtual machine, which will protect the application security and resources.

Attacks on applications are still possible, and the “sand box” environment prevents from creating a central security protection in the system.

### SUMMARY

The purpose of the invention is to provide ability to detect all types of attacks and the nature of an attack.

The invention methods will create software traps which will attract malicious software by creating software objects (files, network resources) which are similar to those created by the application.

The invention method is about mimicking software objects which are referenced by the application such as files and network resources (potentially internet resources). Such software objects will be created by an additional layer which is monitoring the system calls of the applications. These software objects will have the same characteristics as the original and will be referenced in the same way.

Any reference to such software objects is considered a potential attack, as the original software is not intended to address them. A monitoring software can detect the type of actions/changes done on these software objects.

### DETAILED DESCRIPTION

### Brief Description of the Drawings

FIG. 1 Described a system description of the software trap generation and monitoring method

The method described is good for any computing system, which comprised a CPU, execution memory, storage memory, 10 devices and a networked—wired of wireless.

Specifically this can be a smart phone or a tablet.

The invention method works in several steps:
1. Monitoring an application and detecting references to software objects such as files or network resources.
2. Creating mimicked objects with the same characteristics as the original detected objects.
3. Creating same references to the mimicked objects as to the original objects
4. Detecting references to the mimicked objects (if the original software is working properly it will never issue such references).

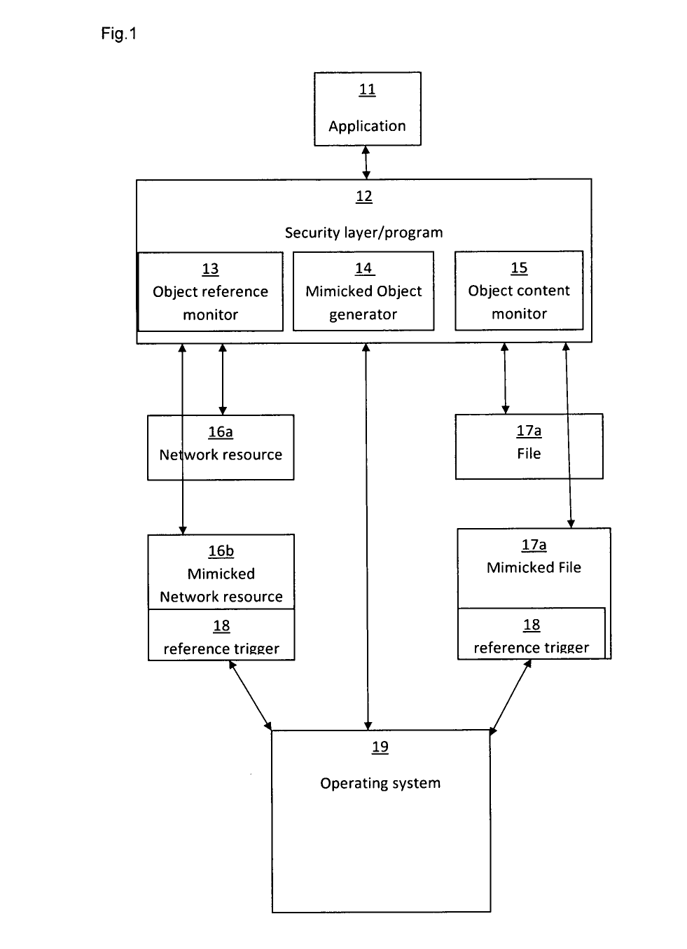

FIG. 1 describes the software elements in the system for the generation of mimicked software objects and their monitoring for the detection of malicious software activities.

An application 11 is installed.

For generic computing systems there can be a single security program 12 for the whole system, which can handle multiple applications.

As an alternative a security layer 12 is created per application (this is a must in certain mobile phone systems) and will be installed together with it as one application and “sandbagged” together with it. This will have an advantage, as its operations would look to attacker software as the original application.

The security layer/program will have several elements:
1. Object reference monitor 13
2. Mimicked object creator 14
3. Mimicked object monitor. 15

The object reference monitor 13 will observe all system calls made by the application. It will observe if this is a new reference to an object or a repetitive reference. The software objects can be files 17a or network resource 16a (potentially internet resources).

The mimicked object creator 14 will create mimicked software objects like these referenced (16b, 17b). They will have the same characteristics as the original software objects (file size, network characteristics). In addition, all actions/references done to the original object will be done on them (read, write, transfer, copy). It is expected that malicious software aiming to attack this application will reference these software objects. An unlimited number of such software objects can be created per application.

Also, since certain software objects can be referenced by multiple applications, a mimicked object will be created per reference per application. Under one embodiment, there will be a reference triggering mechanisms 18 in each object, which will generate an interrupt to the operating system 19 once such a reference is made. All references to a mimicked object will be done only by a malicious code.

It should be noted that illegal references may be done by the application itself—due to malware in it.

The operating system can call mimicked object monitoring 15 which will reference the reported mimicked object and observe what changes where done on its content.

Under another embodiment, there will be no such mechanism, but the mimicked object monitoring 15 will from time to time examine the content of the object for any changes done on them.

It can detect if content is erased or changed of transferred.

Once such a detection is done the OS 19 will be notified and it can take actions.

What is claimed is:

1. A method for protecting a computing system against malicious software with the following steps:
a. Monitoring an application and detecting references to software objects such as files or network resources.
b. Creating mimicked objects with the same characteristics as the original detected objects.
c. Creating same references to the mimicked objects as to the original objects
d. Detecting references to the mimicked objects (if the original software is working properly it will never issue such references)

2. A computing system incorporate the following element:
a. Applications
b. Security program
c. Software objects
d. Mimicked software objects

3. A computing system as in claim 2, where the security program incorporate the following elements:
a. Object reference monitor which will detect what software objects are referenced by an application.
b. Mimicked object creator which will create software objects with similar characteristics at the above referenced objects and similar references to such objects
c. Mimicked object monitor which will detect references to such objects

4. A computing system as in claim 2, where the security program can handle multiple applications.

5. A computing system as in claim 2, where the will be a security layer per application, installed together with the application.

6. A computing system as in claim 3 where the mimicked object monitor will issue call from time to time to the mimicked objects and examine if the content has changed.

7. A computing system as in claim 3 where the mimicked objects will incorporate trigger mechanism which will detect references to this object and will generate an interrupt to the OS which will call the mimicked object monitoring.
